(19) United States
(12) Patent Application Publication
(10) Pub. No.: US 2020/0211306 A1
(43) Pub. Date: Jul. 2, 2020

(54) PARKING SYSTEM AND METHOD

(71) Applicant: INUGO SYSTEMS LIMITED, Takapuna, Auckland (NZ)

(72) Inventor: Eli Jozeph Thomas, Auckland (NZ)

(21) Appl. No.: 16/646,965

(22) PCT Filed: Sep. 14, 2018
(86) PCT No.: PCT/NZ2018/050123

§ 371 Date: Mar. 12, 2020

Related U.S. Application Data
(60) Provisional application No. 62/559,473, filed on Sep. 15, 2017.

(51) Int. Cl. G07C 9/00; G06Q 30/02; G07B 15/06; H04W 4/80

(52) U.S. Cl. CPC G07C 9/00182; G07C 9/00896; H04W 76/14; G07B 15/063; H04W 4/80; G06Q 30/0207

(57) ABSTRACT

A system for controlled entrance into at least one parking facility having a barrier is described, the system, comprising: a barrier controller, the barrier controller comprising: one or more processors; memory in communication with the one or more processors a Bluetooth communication device; and a barrier trigger; wherein the one or more processors are programmed to: broadcast via the Bluetooth communication device a UUID and a DeviceID; receive a communication initiation request from a mobile device; open a Bluetooth communication channel with the mobile device; receive via the Bluetooth communication device at least one barrier open code; check the validity of the barrier open instruction; trigger the barrier via the barrier trigger to open the barrier; and communicate the barrier opening to a system controller.

### FIELD

This invention relates to a parking system and method

### BACKGROUND

When Bluetooth is used to communicate between two devices at least one device must continuously broadcast a small packet of information to identify that the device exists to other Bluetooth devices and applications. In the case of an entry controller for a car park it is usually the car park controller that broadcasts the information. When the small packet is received, other devices, such as a mobile phone must then ‘interrogate’ the device, asking it for more information about what type of device it is, and the device identifier.

An application on a mobile phone must therefore continuously interrogate every device that is available to determine whether or not it is a controller it wants to communicate with. Given the number of Bluetooth devices, this is a very ‘cycle intensive’ process that wastes resources and batteries.

Even once the application determines that the device is a Bluetooth controller it want to communicate with, then the application still has to go through the connection process. This time slows down the user experience.

In the case of Bluetooth used in relation to controlled entry into a car park it would be desirable to provide a system and method to speed up the identification and connectivity of the controller and an application on a mobile phone.

It is an object of the invention to provide an improved parking system and method or to at least provide the public or industry with a useful choice.

### SUMMARY

According to one example embodiment there is provided a system for controlled entry into at least one parking facility having a barrier, comprising:
a barrier controller, the barrier controller comprising:
one or more processors;
memory in communication with the one or more processors
a Bluetooth communication device; and
a barrier trigger;
   wherein the one or more processors are programmed to:
broadcast via the Bluetooth communication device a Bluetooth UUID and a DeviceID;
receive a communication initiation request from a mobile device;
open a Bluetooth communication channel with the mobile device;
receive via the Bluetooth communication device at least one barrier open code;
check the validity of the barrier open instruction;
trigger the barrier via the barrier trigger to open the barrier; and
communicate the barrier opening to a system controller.

Preferably the barrier open code is encrypted.

Preferably the barrier controller is connected to the internet.

Preferably the barrier controller and the system controller are connected via the internet.

Preferably the barrier controller and system controller communicate via the mobile device.

Preferably the barrier controller communicates with the mobile device using the Bluetooth channel and the mobile device forwards the communications with the system controller via the internet

Preferably the at least one barrier open code is two barrier open codes, one of the barrier open codes useable to allow entry of a vehicle to the car parking facility and the other barrier open code useable to permit exit of a vehicle from the car parking facility.

Preferably the mobile device is part of a vehicle management system.

Preferably the one or more processors are further programmed to receive from the system controller and instruction to trigger the barrier via the barrier trigger to open the barrier.

According to a further example embodiment there is provided a method for controlling entry into at least one parking facility having a barrier and a barrier controller, the barrier controller comprising:
one or more processors;
memory in communication with the one or more processors
a Bluetooth communication device; and
a barrier trigger;
   the method comprising the steps of:
broadcasting via the Bluetooth communication device a Bluetooth UUID and a DeviceID;
receiving a communication initiation request from a mobile device;
opening a Bluetooth communication channel with the mobile device;
receiving via the Bluetooth communication device at least one barrier open code;
checking the validity of the barrier open instruction;
triggering the barrier via the barrier trigger to open the barrier; and
communicating the barrier opening to a system controller.

Preferably the barrier open code is encrypted.

Preferably the barrier controller is connected to the internet.

Preferably the system controller and system controller are connected via the internet.

Preferably the barrier controller and system controller communicate via the mobile device.

Preferably the barrier controller communicates with the mobile device using the Bluetooth channel and the mobile device forwards the communications with the system controller via the internet

Preferably the at least one barrier open code is two barrier open codes, one of the barrier open codes useable to allow entry of a vehicle to the car parking facility and the other barrier open code useable to permit exit of a vehicle from the car parking facility.

Preferably including the step of receiving from the system controller an instruction to trigger the barrier via the barrier trigger to open the barrier.

Preferably the mobile device is part of a vehicle management system.

According to another example embodiment there is provided system for controlled entry into at least one parking facility having a barrier and barrier controller, comprising:
a mobile device, the mobile device having:
   one or more processors;
   memory in communication with the one or more processors
   a Bluetooth communication device; and
   a networking device;
wherein the one or more processors are programmed to:
   receive via the Bluetooth communication device a UUID and a DeviceID from the barrier controller;
   validate the UUID;
   send the UUID, DeviceID, a userID and a request for carparking to a system controller;
   receive from the system controller at least one barrier opening code
   open a Bluetooth communication channel with the barrier controller; and
   send via the Bluetooth communication device the barrier open code.

Preferably the barrier open code is encrypted.

Preferably the barrier controller is connected to the internet.

Preferably the barrier controller and the system controller are connected via the internet.

Preferably the barrier controller and system controller communicate via the mobile device.

Preferably the barrier controller communicates with the mobile device using the Bluetooth channel and the mobile device forwards the communications with the system controller via the internet

Preferably the at least one barrier open code is two barrier open codes, one of the barrier open codes useable to allow entry of a vehicle to the car parking facility and the other barrier open code useable to permit exit of a vehicle from the car parking facility.

Preferably the one or more processors are further programmed to communicate a validation or discount code to the system controller.

Preferably the mobile device is part of a vehicle management system.

According to another example embodiment there is provided a method for controlling entry into at least one parking facility having a barrier and barrier controller, using a mobile device, the mobile device having:
one or more processors;
memory in communication with the one or more processors
a Bluetooth communication device; and
a networking device;
   the method comprising the steps of:
receiving via the Bluetooth communication device a UUID and a DeviceID from the barrier controller;
validating the UUID;
sending the UUID, DeviceID, a userID and a request for carparking to a system controller;
receiving from the system controller at least one barrier opening code
opening a Bluetooth communication channel with the barrier controller; and
sending via the Bluetooth communication device the barrier open code.

Preferably the barrier open code is encrypted.

Preferably the barrier controller is connected to the internet.

Preferably the barrier controller and the system controller are connected via the internet.

Preferably the barrier controller and system controller communicate via the mobile device.

Preferably the barrier controller communicates with the mobile device using the Bluetooth channel and the mobile device forwards the communications with the system controller via the internet

Preferably the at least one barrier open code is two barrier open codes, one of the barrier open codes useable to allow entry of a vehicle to the car parking facility and the other barrier open code useable to permit exit of a vehicle from the car parking facility.

Preferably including the step of communicating a validation or discount code to the system controller.

Preferably the mobile device is part of a vehicle management system.

According to another example embodiment there is provided a system for validation of parking comprising:
a validation tag having:
one or more processors;
memory in communication with the one or more processors; and
a Bluetooth communication device;
   wherein the one or more processors are programmed to:
broadcast via the Bluetooth communication device a Bluetooth UUID and a DeviceID;
receive a communication initiation request from a mobile device;
open a Bluetooth communication channel with the mobile device; and
transmit to the mobile device a validation code.

According to another example embodiment there is provided a method for validation of parking using a validation tag, the validation tag comprising:
one or more processors;
memory in communication with the one or more processors; and
a Bluetooth communication device;
the method comprising the steps of:
   broadcasting via the Bluetooth communication device a Bluetooth UUID and a DeviceID;
   receiving a communication initiation request from a mobile device;
   opening a Bluetooth communication channel with the mobile device; and
   transmit a validation code.

According to another example embodiment there is provided a system for validation of parking using a validation tag, the system comprising:
a mobile device, the mobile device having:
   one or more processors;
   memory in communication with the one or more processors
   a Bluetooth communication device; and
   a networking device;
      wherein the one or more processors are programmed to:
receive via the Bluetooth communication device a UUID and a DeviceID from the validation tag;
validate the UUID;
transmit a communication initiation request to the validation tag;
opening a Bluetooth communication channel with the validation tag;
receive a validation code from the validation tag; and
send the UUID, a validation code, a userID to a system controller.

According to another example embodiment there is provided a method for validation of parking using a validation tag, the method comprising the steps of:
receiving via the Bluetooth communication device of a mobile device a Bluetooth UUID and a DeviceID;
validating the UUID;
opening a Bluetooth communication channel with the validation tag;
receive a validation code from the validation tag; and
sending the UUID, a validation code, a userID to a system controller.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e., they will be taken to mean an inclusion of the listed components which the use directly references, and possibly also of other non-specified components or elements.

Reference to any document in this specification does not constitute an admission that it is prior art, validly combinable with other documents or that it forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention, in which:

FIG. 1 is a diagram of components of the present invention;

FIG. 2 is a diagram of the data flow of the present invention.

FIG. 3 is a screen shot of the application of the present invention on a mobile device illustrating the validation screen;

FIG. 4 is a further screen shot of the application of the present invention on a mobile device illustrating a further validation screen;

FIG. 5A is a screen shot of the application of the present invention on a mobile device illustrating the offer screen;

FIG. 5B is a screen shot of the application of the present invention on a mobile device illustrating a further offer screen;

FIG. 6 is a block diagram of the system controller of the present invention;

FIG. 7 is a block diagram of the barrier controller of the present invention; and

FIG. 8 is a block diagram of an exemplary mobile device of the present invention;

### DETAILED DESCRIPTION

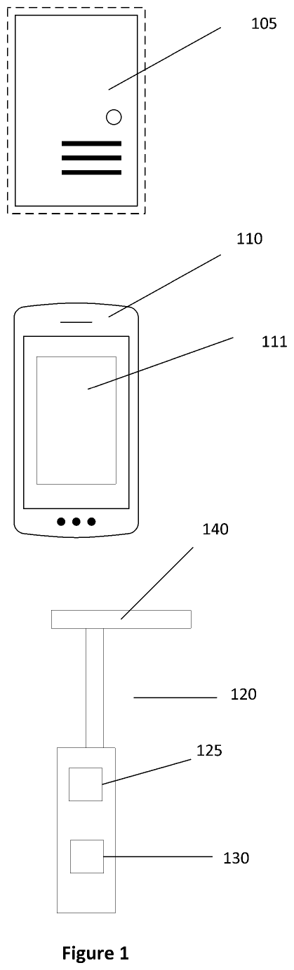

FIG. 1 illustrates the components of the present invention according to an example embodiment. The system includes a system controller 105, an application 111 on a mobile device 110 and a barrier 120 including a barrier controller 130 for controlling the entry to a car park or other facility. The barrier controller 130 may also include barrier or gate actuator 125 and a barrier arm 140.

While the application 111 is described as installed on a mobile device 110, the application may also be integrated into the computer management system of a vehicle for example and the vehicle management system would act as the mobile device.

The system controller 105 is located in the cloud and has network connectivity including connectivity to the internet.

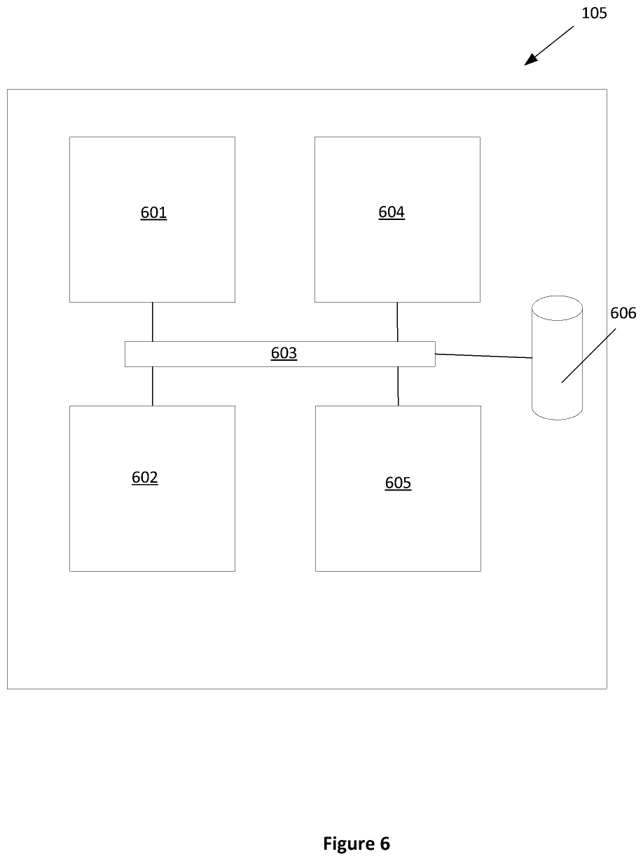

In summary, referring to FIG. 6, the system controller 105 includes at least one processor 601, one or more memory devices 602 or an interface for connection to one or more memory devices, input and output interfaces for connection to external devices in order to enable the system to receive and operate upon instructions from one or more users or external systems, a data bus 603 for internal and external communications between the various components, and a suitable power supply 605. Further, the system controller 105 includes one or more communication devices 604 (wired or wireless) for communicating with external and internal devices, and one or more input/output devices, such as a display, pointing device, keyboard or printing device and one or more data storage devices such as hard drives 606.

The processor of the system controller 105 is arranged to perform the steps of a program stored as program instructions within the memory device. The program instructions enable the various methods of performing the invention as described herein to be performed. Alternatively, the program instructions may be implemented as an electronic circuit.

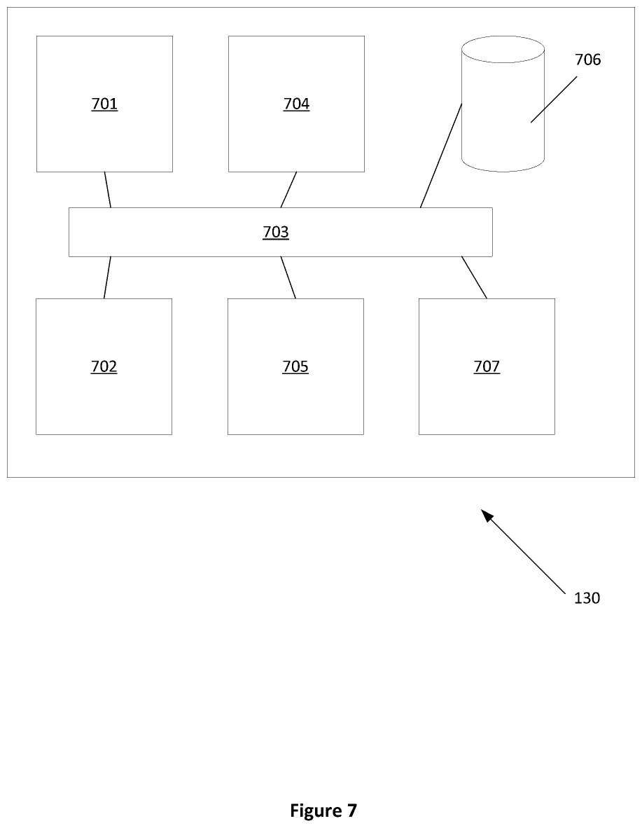

Referring to FIG. 7 the barrier 120 for controlling entry has a barrier controller 130. The barrier or gate controller 130 includes one or more processors 701, memory 702 in communication with the one or more processors, input and output interfaces for connection to external devices in order to enable the system to receive and operate upon instructions from one or more users or external systems, a data bus 703 for internal and external communications between the various components, and a suitable power supply 705. The barrier or gate controller 130 also has one or more communication devices 704 (wired or wireless) for communicating with external and internal devices, the communication devices including a Bluetooth communication device; and a barrier or gate trigger 707. The barrier or gate controller 130 further includes one or more data storage devices such as storage memory 706. Alternatively, the program instructions may be implemented as an electronic circuit.

The barrier or gate trigger 707 is connected to a barrier or gate actuator 125 that opens and closes the barrier arm 140. While illustrated with a barrier arm the barrier could alternatively be a gate a door or other entry control devices.

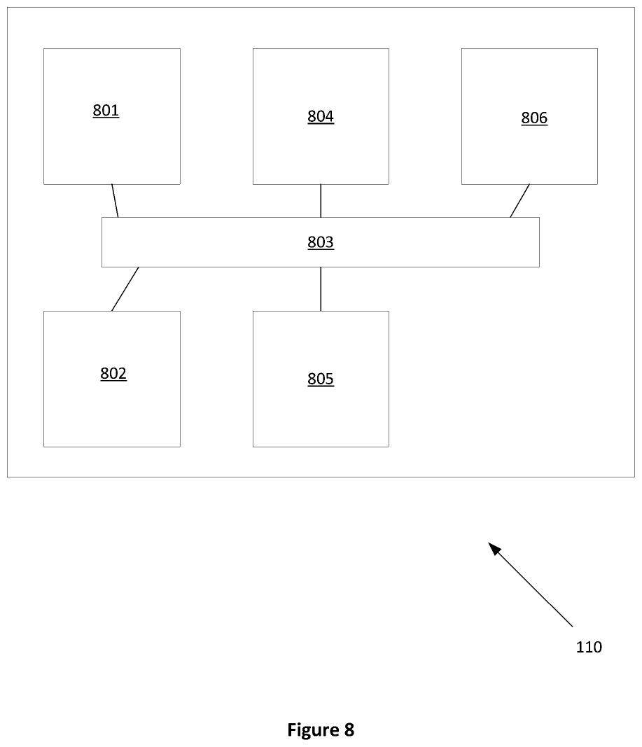

A mobile device 110, illustrated as a block diagram in FIG. 8 is in one embodiment a mobile phone. As discussed above the application could be incorporated into the computer management system of a vehicle and so the mobile device 110 would be integrated into the vehicle management system.

The mobile device illustrated in FIG. 8 has at least one processor 801, one or more memory devices 602 a data bus 803 for internal and external communications between the various components, and a suitable power supply 805. Further, the mobile device 110 includes one or more communication devices 804 (wired or wireless) for communicating with external and internal devices, and one or more input/output devices 806, such as a display, pointing device, keyboard or touch pad. The communication devices including a Bluetooth communication device and at least one network device for providing internet connectivity. The at least one network device may be Wifi or a mobile network device internet or both.

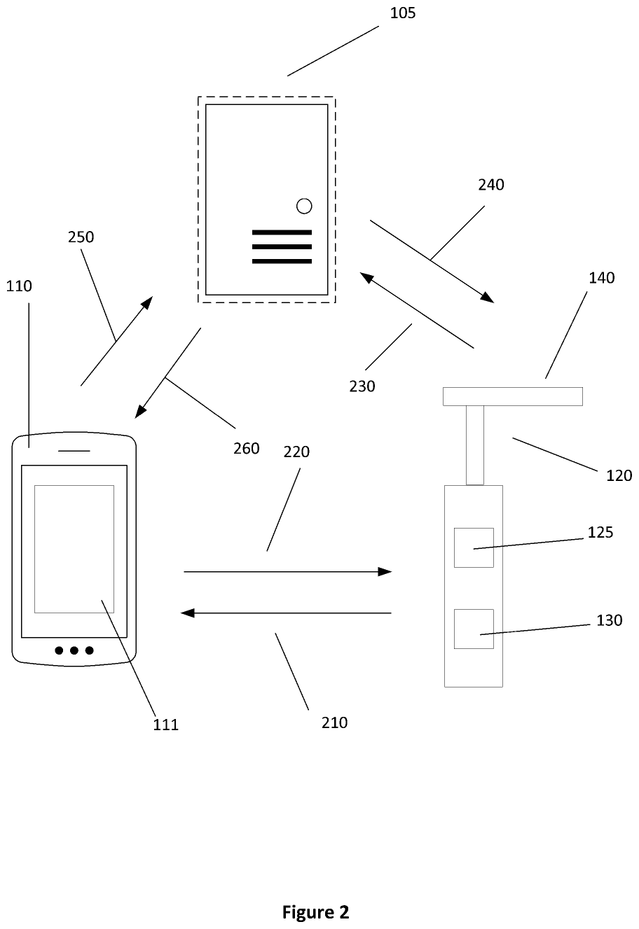

Referring to FIG. 2 in operation the barrier or gate controller 130 using the Bluetooth communication device broadcasts 210 the complete UUID in its identification message that is continuously transmitted. The UUID is allocated and unique to the system.

The UUID is received by the Bluetooth communication device of the mobile device 110 and provided to the application 111. The application 111 filters or validates out all Bluetooth messages except this specific UUID. This saves cycles and battery life by not having to interrogate other Bluetooth devices beacons.

When the application 111 receives the unique UUID the application immediately connects 220 to the barrier/gate controller.

Once connected the application 111 sends 250 the UUID, a barrier controller identifier (DeviceID) and the UserID of the user to system controller 105.

The system controller 105 checks whether the user has access to the barrier, and if the user has access, a green ‘open’ button appears on the application 111. Other checks such as availability of credit etc may also be carried out by the system controller 105.

The system controller 105 sends 260 an open code to the application 111. In a further embodiment, the system controller 105 may also send 260 an exit code along with the open code, this enables the application 111 to open a barrier on exit without needing internet connectivity, which may be problematic in a building. In one embodiment, the codes may be encrypted.

When the application 111 receives the code (or codes) the application provides an open button for a user to tap. When the user taps the open button in the application 111 the application 111 sends the open code to the gate/barrier controller 130 via the Bluetooth communication channel previously established.

In a further embodiment the gate may open without the user having to tap open. Exampling include with the carpark is at the vehicle users home or work. Further when the application is included in the computer management system of a vehicle including an autonomous vehicle the vehicle management system may send the ‘open tap’ without the user having to manually tap a screen.

The gate/barrier controller 130 triggers the opening of the barrier via the barrier or gate actuator 125 that opens and closes the barrier arm 140. The gate/barrier controller 130 counts all open barrier commands (whether the opening was caused by the application 111, or through other means). This allows system controller to maintain an inventory of the available carparks at a site (by counting in's and out's).

The barrier or gate controller 130 returns information to the system controller 105 confirming that the gate opened and includes information about previous openings that may or may not be related to the use of the application 111.

The barrier or gate controller 130 may communicate with the system controller 105 over a network either Wi-Fi wired or mobile network or via the Bluetooth channel open with the mobile device 110 using the network connection of the mobile device 110.

When the user wants to exit, they drive to the exit barrier, which may or may not be the same barrier as the entry barrier. At the exit the application 111 and an exit barrier controller communicate, the application 111 then displays an open button and when the user taps on the open button the exit code is sent to the barrier or gate controller 130 which opens the barrier. As above in some situations the gate may open without the user having to tap open.

No internet connection is required to open the barrier because the exit code was previously stored. However, an internet connection is required after the event to send information to the system controller 105 for billing purposes. This communication may be sent via the barrier or gate controller 130 if it has network connectivity or may be stored and sent by the mobile device 110 when it has internet connectivity.

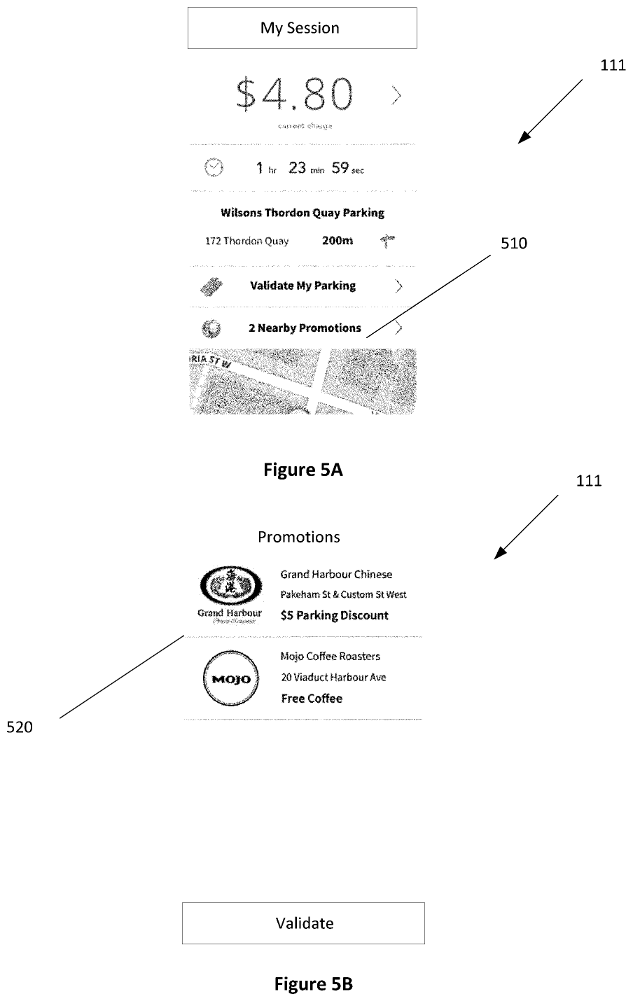

In further embodiments, the application 111 may be used by the system controller 105 to communicate offers 510, 520, illustrated in FIGS. 5A and 5B to a user such as for example a free or low cost upgrade to preferred parking in one example covered parking. In one preferred embodiment, the offers 510, 520, are related to the location of the mobile device 110 and the user of the mobile device 110 based on the UserID.

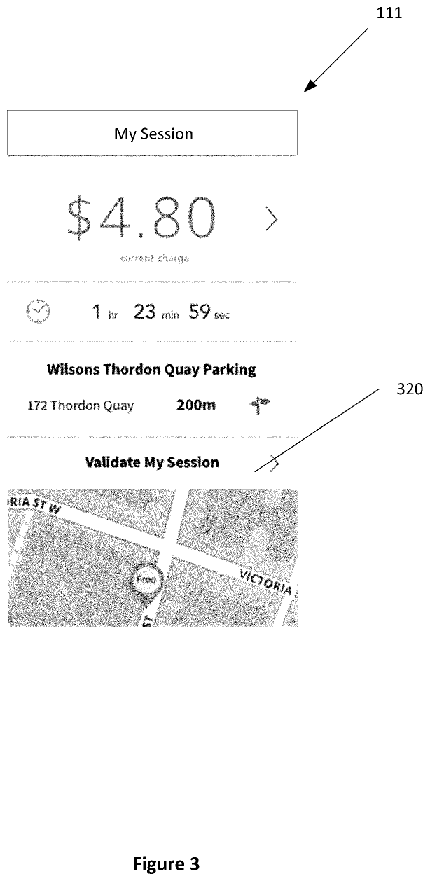

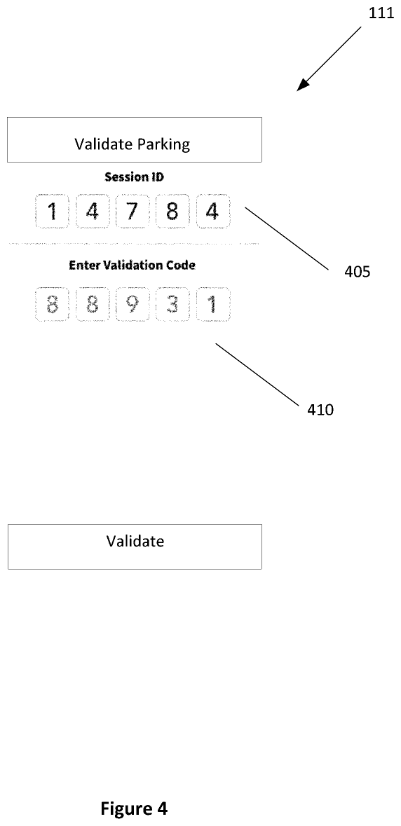

Further as illustrated in FIGS. 3 and 4 the application 111 may be used to allow a user to scan an image or otherwise enter a discount or validation code 320 that is sent to the system controller 105. Example validation scenarios include:
1. Retailer or operator gives the user a unique code to enter 410 into the application 111 on the phone (like a discount coupon), or gives them a QR code to scan which contains the code.
2. The user shows the retailer or operator their session code 405 using the application, which the retailer or operator then enters into a retailer application.
3. The user taps their phone to a Bluetooth beacon provided by the operator or retailer.

In all cases, the result is that the user is given a different rate structure than they had before then. The new rate structure could be discounted or free.

Further the system may include a validation beacon located in a retailer or other validator such as a service provider who validates client car parking. To validate parking a user can simply tap a validation Bluetooth beacon with their mobile device 110 to receive a validation code. The application 111 on the mobile device sends the validation code to system controller 105 and the discount associated with the validation code is applied. The validation discount may be the total cost of parking, a reduced rate or a number of hours eg up to two hours. Tap (close proximity) beacons may be used, but some validators may choose to use validation beacons with a longer range so that simply walking into a store or location would validate parking. In one embodiment the validation beacon also transmits the complete UUID in its identification message that is continuously transmitted. The UUID is received by the Bluetooth communication device of the mobile device 110 and provided to the application 111. The application 111 filters out all Bluetooth messages except this specific UUID. This saves cycles and battery life by not having to interrogate other Bluetooth devices beacons.

Further validation data could be made available to enable a parking provider to track and analyse user trends, habits preferences and behaviours. The data could further be used to tailor offers based on user trends, habits preferences and behaviours and to send those offers to the user as described above.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1-18. (canceled)

19. The system for controlled entry into at least one parking facility having a barrier and barrier controller, comprising:
a mobile device, the mobile device having:
one or more processors;
memory in communication with the one or more processors
a Bluetooth communication device; and
a networking device;
wherein the one or more processors are programmed to:
receive via the Bluetooth communication device a UUID and a DeviceID from the barrier controller;
validate the UUID;
send the UUID, DeviceID, a userID and a request for car parking to a system controller;
receive from the system controller at least one barrier opening code;
open a Bluetooth communication channel with the barrier controller; and
send via the Bluetooth communication device the barrier open code.

20-22. (canceled)

23. The system for controlled entry into at least one parking facility as claimed in claim 19 wherein the barrier controller and system controller communicate via the mobile device.

24. The system for controlled entry into at least one parking facility as claimed in claim 23 wherein the barrier controller communicates with the mobile device using the Bluetooth channel and the mobile device forwards the communications with the system controller via the internet.

25. The system for controlled entry into at least one parking facility as claimed in claim 24 wherein the at least one barrier open code is two barrier open codes, one of the barrier open codes useable to allow entry of a vehicle to the car parking facility and the other barrier open code useable to permit exit of a vehicle from the car parking facility.

26. The system for controlled entry into at least one parking facility as claimed in claim 25 wherein the one or more processors are further programmed to communicate a validation or discount code to the system controller.

27. The system for controlled entry into at least one parking facility as claimed in claim 26 wherein the mobile device is part of a vehicle management system.

28. A method for controlling entry into at least one parking facility having a barrier and barrier controller, using a mobile device, the mobile device having:
one or more processors;
memory in communication with the one or more processors
a Bluetooth communication device; and
a networking device;
the method comprising the steps of:
receiving via the Bluetooth communication device a UUID and a DeviceID from the barrier controller;
validating the UUID;
sending the UUID, DeviceID, a userID and a request for car parking to a system controller;
receiving from the system controller at least one barrier opening code;
opening a Bluetooth communication channel with the barrier controller; and
sending via the Bluetooth communication device the barrier open code.

29-31. (canceled)

32. A method for controlling entry into at least one parking facility as claimed in claim 28 wherein the barrier controller and system controller communicate via the mobile device.

33. A method for controlling entry into at least one parking facility as claimed in claim 32 wherein the barrier controller communicates with the mobile device using the Bluetooth channel and the mobile device forwards the communications with the system controller via the internet.

34. The method for controlling entry into at least one parking facility as claimed in claim 33 wherein the at least one barrier open code is two barrier open codes, one of the barrier open codes useable to allow entry of a vehicle to the car parking facility and the other barrier open code useable to permit exit of a vehicle from the car parking facility.

35. The method for controlled entry into at least one parking facility as claimed in claim 34 including the step of communicating a validation or discount code to the system controller.

36. The method for controlling entry into at least one parking facility as claimed in claim 35 wherein the mobile device is part of a vehicle management system.

37. A system for validation of parking comprising:
a validation tag having:
one or more processors;
memory in communication with the one or more processors; and
a Bluetooth communication device;
wherein the one or more processors are programmed to:
broadcast via the Bluetooth communication device a Bluetooth UUID and a DeviceID;
receive a communication initiation request from a mobile device;
open a Bluetooth communication channel with the mobile device; and
transmit to the mobile device a validation code.

38. A method for validation of parking using a validation tag, the validation tag comprising:
one or more processors;
memory in communication with the one or more processors; and
a Bluetooth communication device;
the method comprising the steps of:
broadcasting via the Bluetooth communication device a Bluetooth UUID and a DeviceID;
receiving a communication initiation request from a mobile device;
opening a Bluetooth communication channel with the mobile device; and
transmit a validation code.

39-44. (canceled)
